(19) United States
(12) Patent Application Publication
(10) Pub. No.: US 2010/0293511 A1
(43) Pub. Date: Nov. 18, 2010

(54) COMPUTERIZED EVENT TRACKING WITH AMBIENT GRAPHICAL INDICATOR

(75) Inventors: Bryan T. Agnetta, Seattle, WA (US); Igor Borisov Peev, Seattle, WA (US); Robert Pengelly, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/466,087

(22) Filed: May 14, 2009

(51) Int. Cl. G06F 3/14

(52) U.S. Cl. 715/864

(57) ABSTRACT

Systems and methods for displaying a graphical indication of events on a display of a portable computing device are provided. The system may include an event detector module to receive a series of event notifications over time for one or more predetermined event types, and to process properties of each event notification to determine an intensity value for each event notification. The computing system may further include a graphical user interface engine to present one or more passive tracking indicators corresponding to a predetermined event type, in a location that is visible irrespective of other content displayed on the display. The graphical user interface engine is further configured to, for each event notification, adjust the appearance of the corresponding passive tracking indicator in response to the determined intensity value, such that the appearance of the passive tracking indicator changes over time according to the determined intensity values.

### BACKGROUND

Many computer users track various data streams, such as stock prices, weather, etc., throughout the course of a day. Tracking the aforementioned data streams may require navigation between numerous application programs, web pages, etc., interrupting a user's workflow, inhibiting them from carrying out other operations on the computing device while tracking the data streams. In turn, the interrupted workflow may lead to a decrease in productivity, thereby decreasing the efficiency of the user and increasing the user's frustration with the computing device. Moreover, navigation between or within application programs may become increasingly difficult on portable computing devices used in this manner, due to their small display area as well as modest processing power, exacerbating the aforementioned problems.

### SUMMARY

Systems and methods for displaying a graphical indication of events on a display of a portable computing device are provided. The system may include an event detector module executable on a processor of the portable computing device, to receive a series of event notifications over time for one or more predetermined event types, each event notification having associated properties, and to process the properties of each event notification to determine an intensity value for each event notification. The computing system may further include a graphical user interface engine, executable on the processor of the portable computing device, to present one or more passive tracking indicators. Each passive tracking indicator corresponds to a predetermined event type, and is presented on a display of the computing device in a location that is visible irrespective of other content displayed on the display. The graphical user interface engine is further configured to, for each event notification, adjust the appearance of the corresponding passive tracking indicator in response to the determined intensity value, such that the appearance of the passive tracking indicator changes over time according to the determined intensity values.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of a computing system including a portable computing device configured to generate a passive tracking indicator.

FIG. 2 illustrates a top view of an exemplary portable computing device that may be used in the computing system of FIG. 1, with a plurality of passive tracking indicators presented on a display.

FIG. 3 illustrates a top view of the exemplary portable computing device of FIG. 2, after a series of event notifications has been received by the portable computing device.

FIG. 4 shows a top view of the portable computing device depicted in FIG. 2 before a thematic adjustment has been implemented.

FIG. 5 illustrates a top view of the portable computing device depicted in FIG. 4 after a thematic adjustment has been implemented.

FIG. 6 shows a top view of the portable computing device depicted in FIG. 2 including an exemplary passive tracking indicator.

FIG. 7 illustrates a top view of the portable computing device depicted in FIG. 2 including another exemplary passive tracking indicator.

FIG. 8 shows a process flow depicting a method for use in displaying a graphical indication of events on a display of a portable computing device.

### DETAILED DESCRIPTION

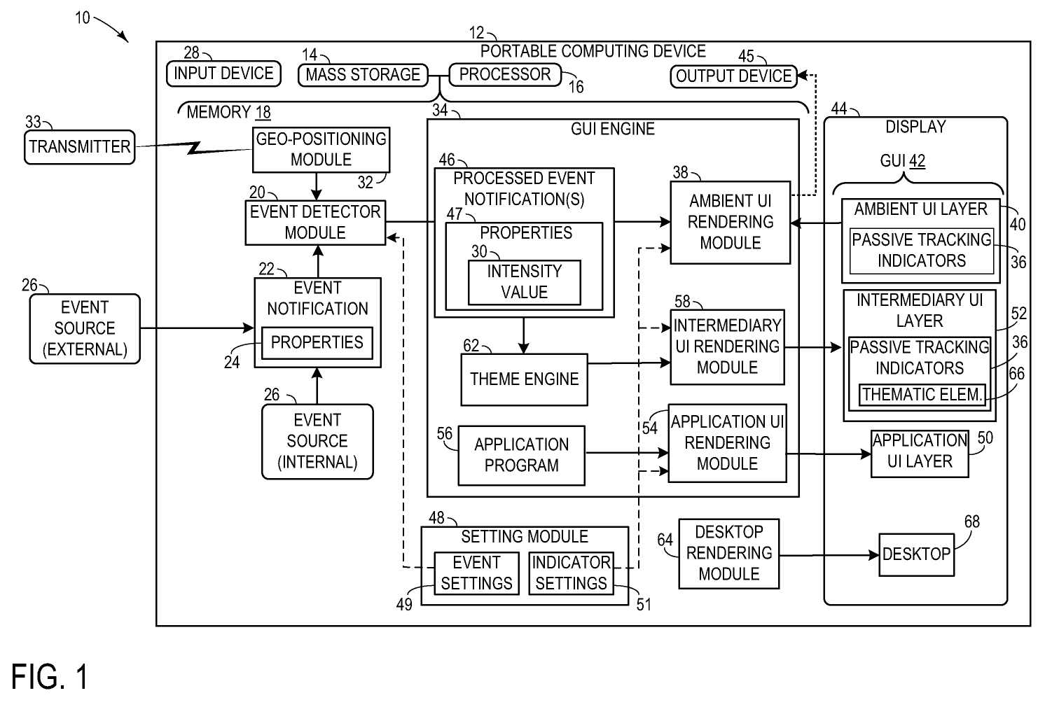

FIG. 1 illustrates a computer system 10 for use in displaying a graphical indication of events on a display 44 of a portable computing device 12. Exemplary portable computing devices include but are not limited to personal data organizers, portable media players, portable phones, laptop computers, etc.

The portable computing device 12 may include various programs stored on mass storage 14 and executable via a processor 16 using portions of memory 18. In some embodiments, the mass storage 14 may be a hard drive, solid state memory, a rewritable disc, etc. The memory 18 may include various programmatic elements described below.

In particular, the portable computing device 12 may include an event detector module 20, which may be configured to receive a series of event notifications 22 over time for one or more event types. Exemplary event types include geo-positioning events, statistical events, behavioral events (e.g. user dieting events, user environmental impact events), weather events, and temporal events (e.g., user-set timer events). It will be appreciated that numerous event types may be used and the aforementioned event types are merely exemplary in nature. A user of portable computing device 12 may register to receive event notifications 22 from various event sources 26, as described below.

The event notifications 22 may have associated properties 24. In some embodiments the properties 24 may be event type specific, and thus for each event type, the properties 24 may correspond to various variables, data types, etc., which are incorporated within event type. For example, a statistical event notification may include financial data such as securities prices and market averages, sports scores pertaining to one or more sports teams, or other statistical data.

Geo-positioning event notifications may include data such as a distance between the portable computing device and an object and the location of an object, the location of the portable computing device 12 being ascertained by an on board geo-positioning module 32 and the location of the object being received via an event notification 22. The objects for which location is determined may include a public transportation vehicle, such as a bus, a second portable computing device, a stop on a museum tour, or other object for which position events have been registered. Remote servers track the position of the objects, and send periodic event notifications of the position of the objects to the portable computing device.

Additionally, a weather event notification may include weather related data such as a temperature, an amount of daily rainfall, and an average wind-speed. It will be appreciated that the aforementioned weather data may be provided for a particular location, such as the city in which the portable computing device 12 is located, for example.

Still further in other examples, the temporal event notifications may include data corresponding to a timer. The timer may be implemented via a user operable timer program executed on the portable computing device 12.

Additionally, the behavioral event notifications may include environmental impact data, such as an estimated energy consumption of a user, which potentially can be estimated by the proximity of the portable computing device 12 to other computing devices while in transit. For example, if several portable computing devices are tracked as traveling a route together on a highway, then it can be determined that a user is carpooling or using public transit, thereby decreasing a user's environmental impact.

Furthermore, the behavioral event notifications may include data corresponding to a user behavior, such as eating or exercise. For example, a diet program may be provided into which the user may input diet parameters such as daily actual and target caloric consumption, etc.

Event notifications for these various event types may be received from one or more event sources 26, which may be internal or external to the portable computing device 12. Examples of internal event sources include a timer program that generates the temporal events discussed above. A user may use an input device 28, such as a touch screen, keyboard, or mouse, to configure such internal event sources to send event notifications under user-specified circumstances. Thus, in one example, a user may press a touch screen button to start a timer via a timer program executed on the portable computing device 12, thereby initiating a series of temporal event notifications. As another example of an internal event source, a diet tracking program may be executed on the portable computing device 12, and a behavioral event notification may be generated by the diet tracking program according to user inputted specifications. According to one scenario, a user may enter the amount, type, etc., of food consumed during the day into the diet tracking program, thereby initiating a series of behavioral event notifications, for example, indicating that a caloric threshold has been reached.

As an example of an external event source, a remote server may be configured to send event notifications to the computing device via wired or wireless communication networks. Remote servers may be provided to send event notifications regarding events of various types, such as the geo-positioning event, statistical events, and weather events discussed above.

In one embodiment, an aggregation program may be provided at a remote server to serve as a gateway event source for event notifications from a plurality of secondary sources. Thus, the aggregation program in turn may configured to aggregate data received from a plurality of other sources, via web crawling, RSS feeds, or other data aggregation techniques. In this way various data streams may be aggregated by a single event source for transmission to the portable computing device 12, decreasing the amount of processing power and bandwidth consumed by the portable computing device to track multiple data streams.

Returning now to the operation of the event detector module 24, this module may also be configured to process the properties 24 of each event notification 22 to determine an intensity value 30 for each event notification. Virtually any scalar value may be scaled to a predetermined intensity scale and represented as an intensity value at which the passive tracking indicator will be displayed. In one example, geo-positioning event notifications may be received via the event detector module 20. As previously mentioned, the geo-positioning event notifications may include data such as the distance between two objects, or the proximity between the personal computing device and a specified object. Thus, the event detector module may translate the scalar value of the distance into an intensity value. In another example, weather event notifications may be received via the event detector module 20. As previously mentioned, weather event notifications may include temperature data for a specified location. Thus, the event detector module may translate the scalar values in the temperature data into an intensity value. As discussed below in detail, the appearance of a passive tracking indicator may be adjusted based on the determined intensity value, thereby providing a visual indicator to the user of the event status.

A geo-positioning module 32, coupled to the event detector module 20, may be configured to determine or receive the geo-positioning location (e.g. longitude and latitude) of the portable computing device 12. For example the geo-positioning module 32 may be configured to communicate with transmitters 33 such as geographical positioning satellites, mobile telephone towers, Wi-Fi transceivers, etc., that may be used to determine position. Further details of the geo-positioning module 32 are discussed below.

A graphical user interface (GUI) engine 34, executable on the processor 16, may be configured to present one or more passive tracking indicators 36 on the display 44, and adjust the appearance of the passive tracking indicators according to the determined intensity values 30 discussed above. The passive tracking indicators may be displayed in locations that are visible irrespective of the other content presented on the display 44. The tracking indicators are referred to as “passive” because they programmatically displayed in response to detection of event notifications, without necessitating user input to be displayed. It will be appreciated that a plurality of passive tracking indicators may be presented, each being visible irrespective of other indicators and other application programs, and that each may correspond to a particular event type.

A variety of rendering modules may be provided to render a passive tracking indicator 36 on a graphical user interface 42 on display 44, at the determined intensity value 30. For example, an ambient user interface (UI) rendering module 38 may be configured to generate an ambient UI layer 40 including the one or more passive tracking indicators 36 within a GUI 42 presented on the display 44. By using the ambient UI layer 40, the passive tracking indicators 36 may be rendered as an overlay respective to other graphical elements presented on the display 44. In this way, the passive tracking indicators may be viewed by the user, regardless of the other program applications in use on the portable computing device 12, allowing a user to track events while performing other operations on the portable computing device. The passive tracking indicator and other content presented in the ambient UI layer 40 is said to be “ambient” because it forms an encompassing environment through which the user views the remaining content that is displayed on display 44. By presenting the passive tracking indicator in the ambient layer 40, cumbersome navigation between application programs may be avoided, thereby increasing a user's productivity and efficiency while working on the portable computing device 12.

It will be appreciated that in other embodiments, the passive tracking indicators may not be included in the ambient UI layer 40, but may be presented according to other rendering methods. Further, in some embodiments, the ambient UI module 38 may be coupled to an output device 45, such as a speaker, and the passive tracking indicator may include audio component, such as a user specified sound icon, a sound quality (e.g. loudness, pitch, etc.) of which may vary based on the intensity value 30.

The GUI engine 34 may be configured, for each processed event notification 46, to adjust the appearance of the corresponding passive tracking indicator in response to the determined intensity value 30, such that the appearance of the passive tracking indicators 36 changes over time according to the determined intensity value 30. During use, the ambient UI rendering module 38 may be configured to receive processed event notification 46 from the event detector module 20. As discussed above, the processed event notification 46 may have properties 47 including an intensity value 30. Adjusting the appearance of the passive tracking indicator may include, in some embodiments, adjusting one or more of the graphical characteristics of the passive tracking indicator, such as hue, opacity, saturation, radiance, size, and shape.

As one particular example, a passive tracking indicator may be configured to change in hue from red to blue and back as temperatures rise and fall through the day, based on a rise and fall in the intensity values received in event notifications, which indicate current temperatures from a specified location. Visual changes such as this in the passive tracking indicator may allow a user to keep track of changes in monitored parameters, such as temperature, without opening a separate application program to view such changes.

The portable computing device 12 may include a setting module 48 configured to communicate with the GUI engine 34 and event detector module 20 to enable a user to adjust event settings 49 and indicator settings 51. The indicator settings 51 specify characteristics influencing the appearance and location of the passive tracking indicator on the display, including as hue, opacity, saturation, radiance, size, shape, and position on the display. In this way, a user may customize the appearance and location of the passive tracking indicator as desired. Further, the type of events which are tracked may be selected via the setting module. Thus, a user may select and save event settings 49 which indicate the type of events that the user would like to register for event notifications, to be tracked by a passive tracking indicator 36.

The GUI 42 may include additional layers such as an application UI layer 50 as well as an intermediary UI layer 52. The application UI layer 50 may be generated via an application UI rendering module 54, executable via the processor 16, and may be configured to render the application UI layer 50 within the GUI 42 on the display 44. The application UI layer 50 may include various graphical elements corresponding to one or more application programs 56 executable via the processor, such as a window within an application-specific GUI is presented for each application program 56.

It will be appreciated that the aforementioned ambient UI layer 40 may be independently rendered, respective to the application UI layer 50. In this way various changes in the appearance of application UI layer content will not affect the ambient UI layer content. This enables the passive tracking indicators 36 to be displayed in a location that is visible, irrespective of other content displayed on the display 44, allowing a user to view the passive tracking indicator while performing other operations on the portable computing device 12, since content in the intermediary UI layer 52 and application UI layer 50 does not interfere with the ambient UI layer.

The intermediary UI layer 52 may be generated via an intermediary UI rendering module 58, executable via the processor 16, configured to render the intermediary UI layer 52 interposed between the ambient UI layer 40 and the application UI layer 50 within the GUI 42 on the display 44. The intermediary UI layer 52 may include various graphical elements commonly owned by a plurality of application programs. The graphical elements of the intermediary UI layer 52 may include passive tracking indicators 36 in the form of thematic elements 60 that are generated by a theme engine 62, and which are shared by a plurality of application-specific GUIs of the application UI layer 50. For ease of programming and to conserver processing power, such thematic elements may be rendered in a separate layer from the application UI layer 50, desktop layer 68 and ambient UI layer 40. Examples of thematic elements 66 include a border “skin” at least partially surrounding a window frame, a control “skin” overlying a GUI control element, a background image, etc. Such thematic elements 66 may have various properties such as hue, opacity, saturation, radiance, size, shape, font, font size, etc., which may be varied to change the appearance of the thematic elements 66. In this way a plurality of windows presented on the display 44 may be rendered in a manner in which they share common thematic elements 66.

To vary the appearance of the thematic elements 66, the theme engine 62 may receive the processed event notifications 46 including varying intensity values 30. In response, the theme engine 62 may adjust the appearance of the thematic elements 66 based on the intensity values 30 received via the processed event notifications 46, for example, by adjusting the hue, opacity, saturation, radiance, size, shape, font, font size, etc., at which such thematic elements are to be rendered based on the intensity values 30. Instructions for rendering the thematic elements with the adjusted appearance are sent from the theme engine 62 to the intermediary UI rendering module 58 for execution and rendering of the thematic elements in the intermediary UI layer 52 on display 44.

Furthermore, a desktop rendering module 64, executable via the processor 16, may be configured to render a desktop 66 within the GUI 42 presented on the display 44. The desktop 66 may include various graphical elements such as a task-bar, a dock, application folders, etc. In some examples, the desktop may be rendered visually beneath the aforementioned UI layers (i.e. the ambient UI layer 40, the intermediary UI layer 52, and the application UI layer 50). Thus, it may be said that the ambient UI layer is rendered atop or visually overlaid on the intermediary UI layer, which in turn is overlaid on the intermediary UI layer, which itself in turn is overlaid on the desktop. It will be appreciated that these layers and their arrangement are exemplary in nature and that additional or alternative layers may be provided in other embodiments.

In some examples, the passive tracking indicators 36 may be at least partially translucent and alpha-blended with other graphical elements presented on the display 44, such that other graphical elements presented on the display may be visible through the passive tracking indicator. In particular, the entirety of the ambient UI layer 40 may be alpha-blended with the intermediary UI layer 52 and/or application UI layer 50 to create a translucent passive tracking indicator. Further, the translucency of a passive tracking indicator may be set by a user via an opacity setting, as opacity is indicates translucency in the inverse. However, it will be appreciated that another suitable technique may be used to apply translucency to the passive tracking indicators.

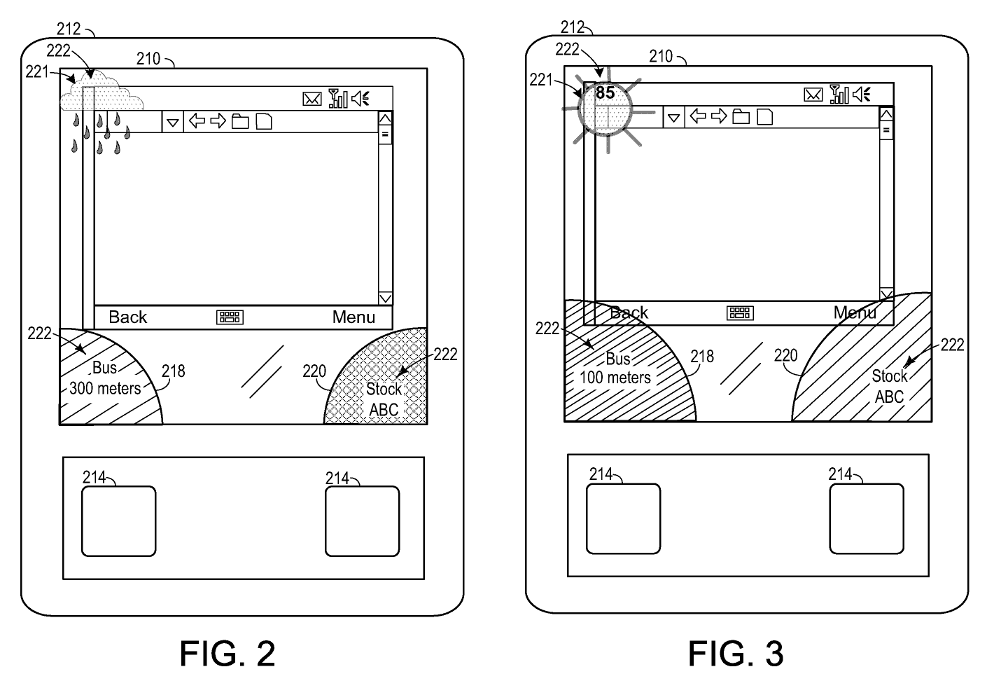

Now turning to FIGS. 2-3, exemplary passive tracking indicators are depicted as rendered within a GUI presented on a display 210 of a portable computing device 212. The portable computing device 212 may include various input mechanisms, such as buttons 214 as well as other suitable input mechanisms. In some embodiments, buttons 214 may include mechanical buttons or buttons formed on a touch-sensitive screen or pad. It should be appreciated that portable computing device 212 provides a non-limiting example of the portable computing device 12 shown in FIG. 1.

FIG. 2 illustrates a first passive tracking indicator 218, a second passive tracking indicator 220, and a third passive tracking indicator 221, presented on the display 210. The first, second, and third passive tracking indicators may include alpha-numeric symbols 222 pertaining to the type of event being tracked. However, it will be appreciated that the alpha-numeric symbols may be excluded in other embodiments. The variation in the cross hatching of the first and the second passive tracking indicators is representative of the variation of graphical characteristics such as hue, translucency, opacity, radiance, etc., of the passive tracking indicators. Therefore, each of the passive graphical indicators may have different graphical characteristics and consequently may be visually distinguishable. For example, each passive indicator may have a different hue, size, etc., allowing a user to visually discern the types of events which are being tracked. Although only two passive tracking indicators are depicted it will be appreciated that any suitable number of passive tracking indicators may be presented on the display.

In the illustrated embodiment, the first passive tracking indicator 218 corresponds to a geo-positioning event type relating to public transportation. In the example, the user has registered for event notifications corresponding to a distance between the location of a vehicle, namely a bus, and a specified location, namely the current location of the portable computing device 212 as determined by the geo-positioning module 32, discussed above. Alternatively the user may have registered for distance to a predetermined geographical location, such as a bus stop. Thus, the distance between the bus and the portable computing device 212 (or bus stop) may be translated into an intensity value via the event detection module 20, also discussed above, and in response the appearance, such as hue and size, of the passive tracking indicator may adjusted, as discussed below. The second passive tracking indicator 220 corresponds to a statistical event type, and in particular, to a change in a stock price of a traded stock. Thus, a change in stock price may be translated into an intensity value, which may be used to adjust the appearance of the passive tracking indicator 220, by changing the size and hue, for example.

As shown in FIG. 3, event notifications having different intensity values for each of the passive tracking indicators 218, 220 is received, and the appearance of the passive tracking indicators is adjusted. In the illustrated example, the size of the first passive tracking indicator 218 and the second passive tracking indicator 220 are adjusted as the intensity value included in an event notification increases. The change in size of the first passive tracking indicator 218 may indicate, for example, that a bus approaches the location of the portable computing device or a predetermined geographical location (e.g. bus stop). The change in size of the second passive tracking indicator 220 may indicate, for example, an upward change in a stock price. In this way, the passive tracking indicator may be configured to visually indicate via a change in visual appearance changes in the intensity values received in event notifications, which in one example can correspond to the portable computing device's proximity to an object, and in another can correspond to a stock price rising or falling. While in this example hue and size are altered, as discussed above it will be appreciated that a variety of other graphical parameters may be altered to change the appearance of the passive tracking indicator, as discussed above.

Finally, the third passive tracking indicator 221 is configured to change shape, from a rain icon in FIG. 2, to a sun icon in FIG. 3, in response to a weather event notification indicating a change in weather from rain to sun for a specified location. The outside temperature for the specified location is depicted as alphanumeric information in the icon. Opacity for each of the rain and sun icons of the third passive tracking indicator is set such that each icon is 50% translucent, and as a result the application interface layer and desktop are visible through the each icon.

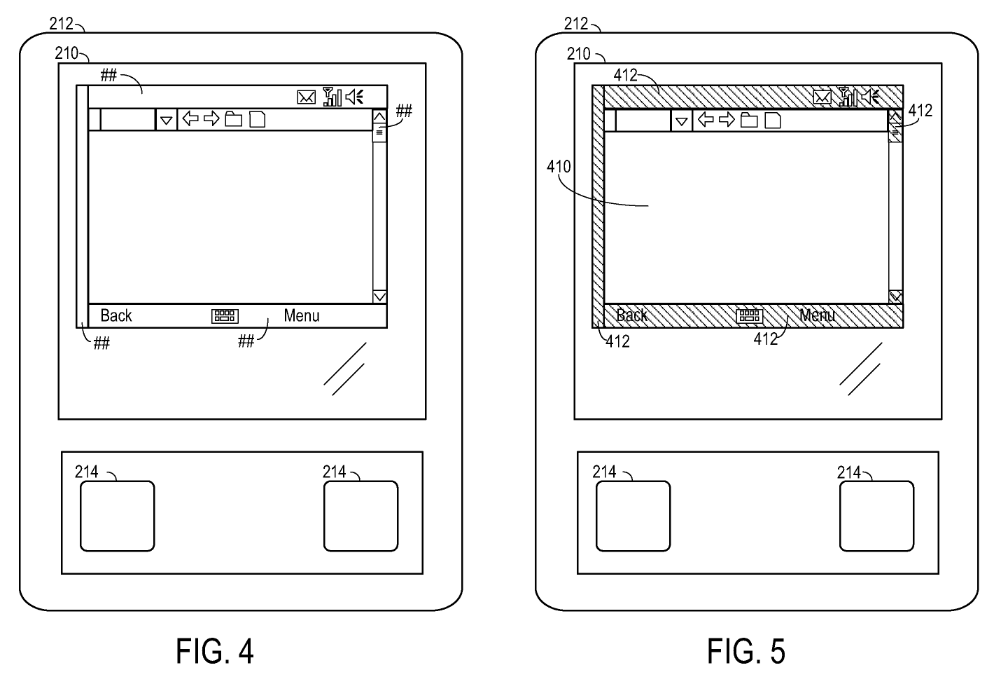

FIGS. 4-5 illustrate a GUI presented on the display 210 of the portable computing device 212 before and after a thematic adjustment has been implemented via an intermediary UI layer 52, as discussed above with regard to FIG. 1. In particular, FIG. 4 illustrates a GUI including a window 410 which may be included in the application UI layer 50. The window may include a thematic element such as a border 412 at least partially surrounding the window 410. The border 412 may be rendered in an intermediary UI layer 52, since it is the type of GUI element that may be common to a plurality of applications. The appearance of the border 412 as well as other thematic graphical elements included in the intermediary UI layer may be adjusted based on an intensity value included in an event notification, as illustrated in FIG. 5. It will be appreciated that one or more of the aforementioned event types may correspond to the thematic adjustment. As one particular example, the thematic adjustment in border 412 may be based on temporal event notifications indicating a timer set by the user has reached elapsed. As previously mentioned, the alteration of the cross-hatching between FIGS. 4 and 5 may correspond to an adjustment of a graphical characteristic such as hue, radiance, saturation, opacity, etc., which thereby alters the appearance of the border 412.

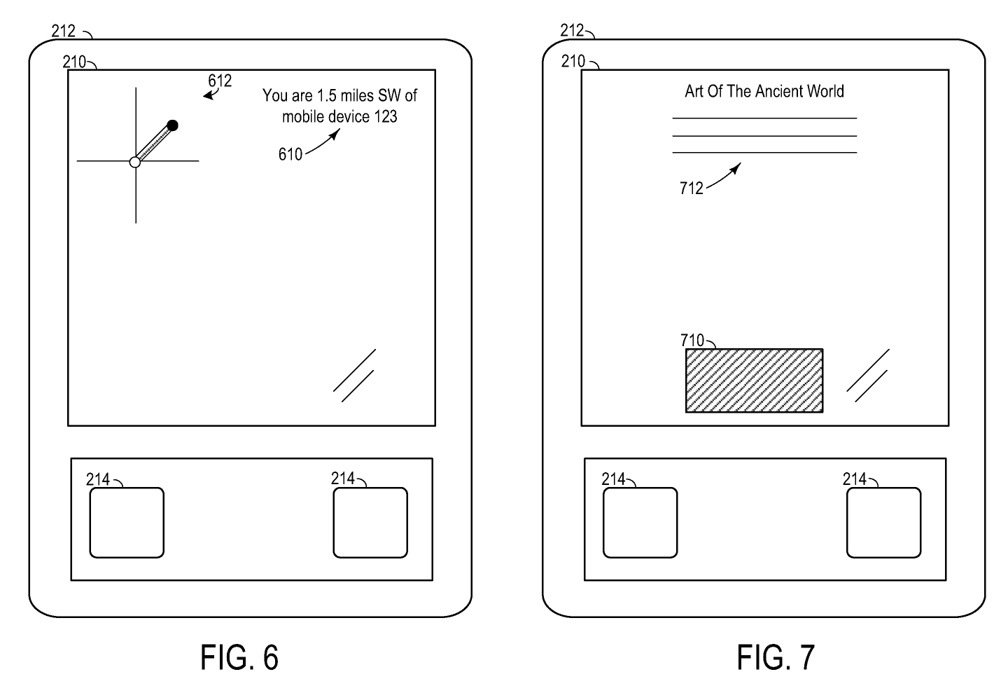

FIG. 6 illustrates the display 210 including a passive tracking indicator which may correspond to a geo-positioning event type. In particular, the geo-positioning event notifications may include data pertaining to a distance between the portable computing device 12 and another mobile device. As depicted, information such as the distance or proximity between the portable computing device and the other mobile device as well as the direction may be displayed via alpha-numeric symbols 610, which may be included in or associated with the passive tracking indicator 612. The depicted passing tracking indicator 612 includes an X-Y axis representing a map oriented northward and centered at the detected location of the portable computing device, and a graphical bar extends outward in the direction of the detected location of the other mobile device. The size and orientation of the bar is dynamically changed to represent the changing distance and direction to the portable computing device 12 as detected by changing intensity values in incoming event notifications.

FIG. 7 illustrates the display 210 including another exemplary passive tracking indicator 710 corresponding to a geo-positioning event type. In particular, the geo-positioning event notification may include data pertaining to a distance between the portable computing device 12 and a pre-determined location on a tour (e.g. tour stop), for example. Therefore, as the distance between the portable computing device and a tour location decreases, a visual characteristic of the passive tracking indicator 710 such as hue, opacity, saturation, radiance, and/or size may increase, indicating to the user that the user is approaching the tour location. Furthermore, alpha-numeric information 712 pertaining to a stop on a tour, for example, may be presented on the display 210. In some embodiments the alpha-numeric information 712 may be presented on the display responsive to user input via an input device (e.g. mouse, keyboard, touch-pad, etc.) above the passive tracking indicator 710, and in other embodiments the alpha-numeric information may be presented programmatically, for example, upon reaching a threshold distance to the tour location. It will be appreciated that a similar interface may be applied to geographic points of interest apart from tours, to indicate a user's proximity and provide information on such a geographic point of interest such as a landmark, park, restaurant, store, information center, etc.

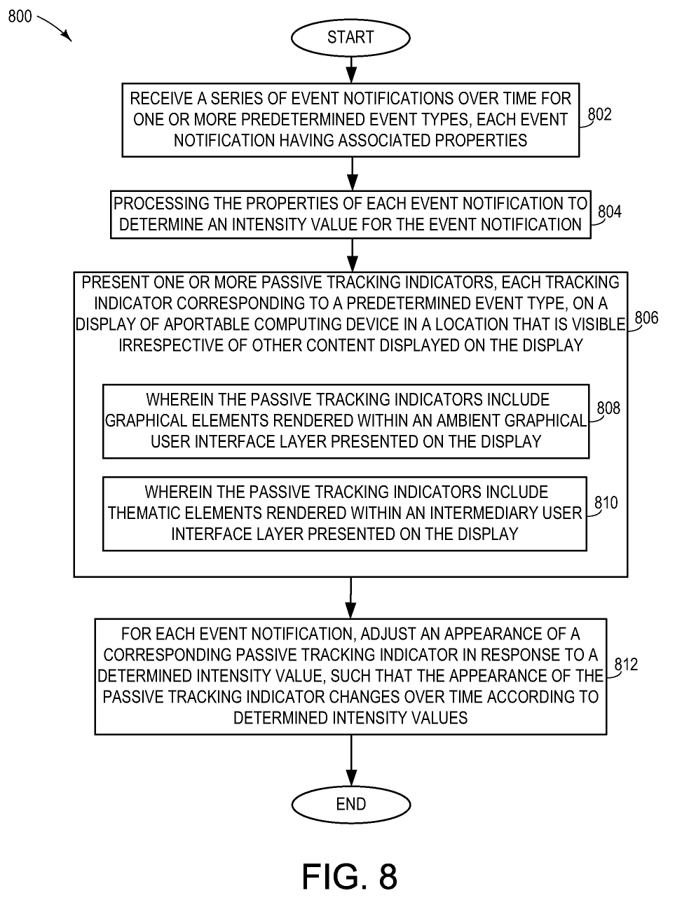

Turning now to FIG. 8, a method 800 is illustrated for use in displaying a graphical indication of events on a display of a portable computing device. Method 800 may be implemented using the software components of the systems and devices described above. However, in alternative embodiments the method 800 may be implemented using other suitable software components.

At 802, the method includes receiving a series of event notifications over time for one or more predetermined event types, each event notification having associated properties. In some embodiments, the event types may include one or more of geo-positioning events, statistical events, weather events, behavioral events, and temporal events, as discussed above. Next at 804, the method includes processing the properties of each event notification to determine an intensity value for the event notification.

At 806, the method includes presenting one or more passive tracking indicators, each tracking indicator corresponding to a predetermined event type, on a display of a portable computing device in a location that is visible irrespective of other content displayed on the display. In some embodiments, the passive tracking indicator may be rendered as an at least partially translucent overlay respective to other graphical content presented on the display, such as application program GUI elements or desktop elements. Furthermore, in other embodiments, a plurality of visually distinguishable passive tracking indicators may be concurrently presented on the display, as described above.

The passive tracking indicators may be rendered in a variety of ways. For example, as shown at 808, the passive tracking indicators may include graphical elements rendered within an ambient graphical user interface presented on the display, as discussed above. Further, as shown at 810, the passive tracking indicators may include thematic elements rendered within an intermediary user interface layer presented on the display, also as discussed above. It will be appreciated that the ambient user interface layer and the intermediary user interface layer are typically separately rendered in a manner that is overlaid on an application program layer and desktop layer presented on the display, thereby ensuring that the passive tracking indicators are visible irrespective of content of various application programs and the desktop.

Next at 812, the method includes for each event notification, adjusting an appearance of a corresponding passive tracking indicator in response to a determined intensity value, such that the appearance of the passive tracking indicator changes over time according to determined intensity values. In some embodiments, adjusting appearance of the passive tracking indicator includes adjusting a graphical characteristic of the passive tracking indicator, such as one or more of the following: hue, opacity, saturation, radiance, size, and shape. Further in some examples, the passive tracking indicator may include an audio component, and therefore adjusting the passive tracking indicator may include adjusting an audio component of the passive tracking indicator thereby triggering sounds audible to the user. Characteristics of the sound, such as loudness or pitch, may controlled to vary with the intensity value.

The systems and methods described above enable multiple events to be passively tracked via a portable computing device, and information about a changing status of the events to be graphically communicated to the user in a manner that does not interrupt a user's workflow, thereby potentially increasing the user's efficiency and satisfaction with the portable computing device.

It will be understood that the term “computing device” as used herein may refer to any suitable type of computing device configured to execute programs. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that a computer-readable storage medium may be provided having program instructions stored thereon, which upon execution by a computing device, cause the computing device to execute the methods described above and cause operation of the systems described above.

It will further be understood that the specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the example embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A computer system for use in displaying a graphical indication of events on a display of a portable computing device, the computer system comprising:
an event detector module executable on a processor of the portable computing device, to receive a series of event notifications over time for one or more predetermined event types, each event notification having associated properties, and to process the properties of each event notification to determine an intensity value for each event notification; and
a graphical user interface engine, executable on the processor of the portable computing device, configured to present one or more passive tracking indicators, each passive tracking indicator corresponding to a predetermined event type, on a display of the computing device in a location that is visible irrespective of other content displayed on the display, wherein for each event notification, the graphical user interface engine is configured to adjust the appearance of the corresponding passive tracking indicator in response to the determined intensity value, such that the appearance of the passive tracking indicator changes over time according to the determined intensity values.

2. The computing system of claim 1, wherein the appearance of the passive tracking indicator is adjusted by adjusting one or more of hue, opacity, saturation, radiance, size, and shape of the passive tracking indicator.

3. The computing system of claim 1, wherein the event types include one or more of geo-positioning events, statistical events, weather events, behavioral events, and temporal events.

4. The computing system of claim 3, wherein the geo-positioning event notifications include properties corresponding to the portable computing device's proximity to an object.

5. The computing system of claim 1, wherein the passive tracking indicator is one of a plurality of visually distinguishable passive tracking indicators that are concurrently presented on the display.

6. The computing system of claim 1, wherein the passive tracking indicator is rendered as an overlay respective to other graphical content presented on the display.

7. The computing system of claim 6, wherein the graphical user interface engine includes an ambient user interface rendering module configured to render the passive tracking indicator in an ambient user interface layer on the display.

8. The computing system of claim 7, wherein the graphical user interface engine further includes an intermediary user interface rendering module configured to render an intermediate user interface layer as interposed between an application user interface layer and the ambient user interface layer; and
wherein the passive tracking indicators include thematic elements rendered in the intermediate user interface layer.

9. The computing system of claim 1, wherein the passive tracking indicator is at least partially translucent, such that other graphical elements presented on the display may be visible through the passive tracking indicator.

10. The computing system of claim 1, further comprising a setting module configured to communicate with the graphical user interface engine and the event detector module to adjust event settings and indicator settings, based on user input;
wherein the event settings indicate a type of event to be tracked by a passive tracking indicator, and the indicator settings specify characteristics influencing the appearance and location of the passive tracking indicator on the display.

11. A method for use in displaying a graphical indication of events on a display of a portable computing device, the method comprising:
receiving a series of event notifications over time for one or more predetermined event types, each event notification having associated properties;
processing the properties of each event notification to determine an intensity value for each event notification;
presenting one or more passive tracking indicators on a display of the portable computing device in a location that is visible irrespective of other content displayed on the display, each passive tracking indicator corresponding to a predetermined event type; and
for each event notification, adjusting the appearance of the corresponding passive tracking indicator in response to each determined intensity value, such that the appearance of the passive tracking indicator changes over time according to each determined intensity value.

12. The method of claim 11, wherein adjusting appearance of the passive tracking indicators includes adjusting one or more of hue, opacity, saturation, radiance, size, and shape of the passive tracking indicator.

13. The method of claim 11, wherein the event types include one or more of geo-positioning events, statistical events, weather events, behavioral events, and temporal events.

14. The method of claim 11, wherein the event notifications associated with geo-positioning events include properties corresponding to a proximity of the portable computing device to an object.

15. The method of claim 11, wherein the passive tracking indicators include graphical elements rendered within an ambient graphical user interface layer presented on the display.

16. The method of claim 11, wherein the passive tracking indicators include thematic elements rendered within an intermediary user interface layer presented on the display.

17. The method of claim 11, wherein adjustment of the passive tracking indicator includes adjusting an audio output corresponding to the passive tracking indicator.

18. The method of claim 11, wherein the passive tracking indicator is rendered as an at least partially translucent overlay respective to other graphical content presented on the display.

19. The method of claim 11, wherein a plurality of visually distinguishable passive tracking indicators are concurrently presented on the display.

20. A method for use in displaying a graphical indication of events on a display of a portable computing device, the method comprising:
receiving a series of event notifications over time for one or more predetermined event type, each event notification having associated properties;
processing the properties of each event notification to determine an intensity value for the event notification;
presenting one or more passive tracking indicators corresponding to a predetermined event type on a display of the portable computing device in a location that is visible irrespective of other content displayed on the display; and
for each event notification, adjusting the appearance of the corresponding passive tracking indicator in response to the determined intensity value, such that the appearance of the passive tracking indicator changes over time according to each determined intensity value;
wherein the passive tracking indicators are at least partially translucent and include graphical elements rendered within an ambient graphical user interface layer presented on the display and/or thematic elements rendered within an intermediary user interface layer presented on the display, the ambient graphical user interface layer and intermediary user interface layer being rendered to as an overlay on an application program layer and a desktop layer of the portable computing device.
